(19) United States
(12) Patent Application Publication
(10) Pub. No.: US 2026/0212746 A1
(43) Pub. Date: Jul. 23, 2026

(54) SWIMMER MONITORING DEVICE AND SWIMMER MONITORING METHOD

(71) Applicant: Pacificnetwork, Inc., Kanagawa (JP)

(72) Inventors: Ichiro KANAMARU, Kanagawa (JP); Toshinori ISHIKAWA, Tokyo (JP)

(21) Appl. No.: 19/143,039

(22) PCT Filed: Nov. 29, 2023
(86) PCT No.: PCT/JP2023/042648

§ 371 Date: Jun. 25, 2025

(30) Foreign Application Priority Data
Dec. 28, 2022 (JP) 2022-212776

(51) Int. Cl. G08B 21/08; G06V 10/82; G06V 20/52; G06V 40/10; G06V 40/20

(52) U.S. Cl. CPC G08B 21/08; G06V 10/82; G06V 20/52; G06V 40/10; G06V 40/20

(57) ABSTRACT

A swimmer monitoring device (10) includes: a means configured to acquire a monitor image obtained by capturing an aquatic location from a position higher than the surface of water; a means configured to acquire swimming-state information outputted from a learned model by inputting the acquired monitor image into the learned model; and a means configured to generate drowning alert information on a swimmer on the basis of the acquired swimming-state information, in which the swimming-state information can include detection information on an alert target swimmer in such a manner as to enable a first-drowning-state and a second-drowning-state to be distinguished from each other, the first-drowning-state being a state of drowning and sinking in water, a second-drowning-state involving a movement of a body and being differing from the first-drowning-state, the alert target swimmer including at least a first-state swimmer estimated to be in the first-drowning-state and a second-state swimmer estimated to be in the second-drowning-state.

### TECHNICAL FIELD

The present invention relates to a video monitoring technique.

### BACKGROUND ART

Water-related accidents frequently occur in aquatic locations such as a pool, the sea, rivers, lakes, or marches. Many of these accidents result in fatal accidents. For this reason, for example, lifesavers, lifeguards, or the like are always stationed in aquatic locations, and efforts have been made to prevent water-related accidents.

In addition, Patent Document 1 described below discloses a pool monitoring system that enables a lifeguard to instantly find a swimmer suspected to be drowning. This system includes: a transmitter worn by a swimmer; a receiver disposed above the surface of water or below the surface of water around a pool and configured to receive ultrasonic waves transmitted from the transmitter; a management server configured to determine whether or not the swimmer is drowning on the basis of the ultrasonic waves received by the receiver; and an eyeglasses-type head mounted display (HMD) mounted on the head of a lifeguard and configured to composite and display computer-graphics image data indicating an alarm at a position aligned with a drowning swimmer in a real-space video. The management server is configured to: identify the position of the swimmer on the basis of a signal received from each receiver; measure the period of time during which the position of this swimmer exists within the region of water; determine whether or not there is any possibility that this swimmer is drowning on the basis of this period of time; and transmit, to the HMD, the positional information on this swimmer and alert information for giving an alarm that there is a possibility of drowning.

### RELATED ART DOCUMENT

### Patent Document

Patent Document 1: Japanese Unexamined Patent Application Publication No. 2012-128680

### SUMMARY OF THE INVENTION

### Problem to be Solved by the Invention

However, the system described above requires a swimmer to wear the transmitter, which imposes a burden on the swimmer. In addition, drowning is determined on the basis of whether or not a swimmer continuously exists within the region of water for a predetermined period of time and whether or not the swimmer does a simple movement. This leads to a possibility that, at the time of determination, the swimmer is already in danger and in a life-threatening state due to lack of oxygen. Thus, this system is difficult to prevent drowning accidents before they happen.

The present invention has been made in view of the circumstances described above, and provides a technique that prevents a drowning accident before it happens without imposing a load on a swimmer.

In the present invention, the term “swimmer” means a person who is in the water in an aquatic location, and the term “aquatic location” means a pool, the sea, a river, a lake, a marsh, or other locations where a person can enter the water.

### Means for Solving the Problem

Each aspect of the present invention can employ the following configurations in order to solve the problems described above.

The first aspect relates to a swimmer monitoring device. The swimmer monitoring device according to the first aspect includes: an image acquiring means configured to acquire a monitor image obtained by capturing an aquatic location from a position higher than a surface of water; an information acquiring means configured to acquire swimming-state information outputted from a learned model by inputting the acquired monitor image into the learned model; and a generating means configured to generate drowning alert information on a swimmer on a basis of the acquired swimming-state information, in which the swimming-state information can include detection information on an alert target swimmer in such a manner as to enable a first-drowning-state and a second-drowning-state to be distinguished from each other, the first-drowning-state being a state of drowning and sinking in water, a second-drowning-state involving a movement of a body and being differing from the first-drowning-state, the alert target swimmer including at least a first-state swimmer estimated to be in the first-drowning-state and a second-state swimmer estimated to be in the second-drowning-state.

A second aspect relates to a swimmer monitoring method. The swimmer monitoring method according to the second aspect performed by one or more processors that can use a learned model includes the steps of: acquiring a monitor image obtained by capturing an aquatic location from a position higher than a surface of water; acquiring swimming-state information outputted from the learned model by inputting the acquired monitor image into the learned model; and generating drowning alert information on a swimmer on a basis of the acquired swimming-state information, in which the swimming-state information can include detection information on an alert target swimmer in such a manner as to enable a first-drowning-state and a second-drowning-state to be distinguished from each other, the first-drowning-state being a state of drowning and sinking in water, a second-drowning-state involving a movement of a body and being differing from the first-drowning-state, the alert target swimmer including at least a first-state swimmer estimated to be in the first-drowning-state and a second-state swimmer estimated to be in the second-drowning-state.

Note that the other aspects according to the present invention may include a computer program that causes one or more computers to perform the method according to the second aspect described above and a computer-readable storage medium in which the above-mentioned computer program is recorded. This storage medium includes a non-transitory tangible medium.

### Effect of the Invention

With the aspects described above, it is possible to provide a technique that prevents a drowning accident before it happens without imposing a load on a swimmer.

### BRIEF DESCRIPTION OF THE DRAWINGS

FIG. 1 is a diagram schematically illustrating an example of a hardware configuration of a swimmer monitoring system according to a first embodiment.

FIG. 2 is a diagram illustrating an example of a monitor image.

FIG. 3 is a diagram schematically illustrating an example of a configuration of software for a monitoring device according to the first embodiment.

FIG. 4 is a diagram illustrating an example of a monitor image included in drowning alert information.

FIG. 5 is a diagram illustrating an example of detection information on alert target swimmers in various types of swimming states.

FIG. 6 is a diagram illustrating an example of a drowning-alert notification screen displayed on a user terminal.

FIG. 7 is a flowchart indicative of an example of operations of the monitoring device according to the first embodiment.

FIG. 8 is a diagram illustrating examples of various types of swimming states of swimmers with a float.

FIG. 9 is a diagram illustrating an example of detection information on a third-state swimmer (alert target swimmer) estimated to be in a third-drowning-state.

### DESCRIPTION OF EMBODIMENTS

Below, embodiments according to the present invention will be described. Note that the embodiments described below are given as examples, and the present invention is not limited to the configurations of the embodiments below.

First, the outline of the present embodiment will be described before details of the present embodiment are described. A swimmer monitoring device according to the present embodiment (hereinafter, referred to as the present device) includes at least an image acquiring means, an information acquiring means, and a generating means.

The present device may be one computer such as a monitoring device 10 that will be described later, or may be two or more computers. The present device is configured such that such a computer executes a computer program to achieve the image acquiring means, the information acquiring means, and the generating means. Note that an example of the hardware configuration of the present device will be described later.

The image acquiring means acquires a monitor image obtained by capturing an aquatic location from a position higher than the surface of water.

The acquired monitor image is an image obtained such that a camera disposed higher than the surface of water of the aquatic location captures an image of this aquatic location, and is moving images or a plurality of still images arrayed in a time series. The camera that captures the monitor image may be one camera, or may include two or more cameras. In the example described later, a monitor image captured by one wide-angle camera is acquired. In addition, the image acquiring means may acquire only a monitor image of the aquatic location captured from a position higher than the surface of water, or in addition to this, may acquire a monitor image captured from the underwater of the aquatic location.

The image acquiring means may acquire the monitor image directly from the camera through communication or the like, or may acquire the monitor image through another computer or the like.

The information acquiring means acquires swimming-state information outputted from a learned model by inputting the monitor image acquired by the image acquiring means.

The term “learned model” as used here represents a model obtained through machine leaning using training data, and can also be called an artificial intelligence (AI) model, or a machine leaning (ML) model, or the like.

The learned model used in the present embodiment is a neural network model obtained through deep leaning or the like. However, there is no limitation as to the data structure, learning algorithm, or the like of this learned model. For example, it may be possible to use regression analysis, principal component analysis, or the like.

For example, this learned model is achieved by a combination of a computer program and parameters, a combination of a plurality of functions and parameters, or the like. In a case where the learned model is configured with a neural network, and an input layer, an intermediate layer, and an output layer are regarded as one unit of one neural network, the learned model may indicate one neural network, or may indicate a combination of a plurality of neural networks.

The learned model may be held in a memory of the present device, or may be held in a memory of another device that the present device can access through communication.

Hereinafter, the learned model used in the present embodiment is referred to as an AI model.

The term “swimming-state information” represents information estimated by the AI model with the monitor image being used as input, and represents estimated information on a swimming state of a swimmer shown in the inputted monitor image. In addition, the swimming-state information includes detection information on an alert target swimmer.

The “alert target swimmer” as used here means a swimmer who should be kept an eye on, and includes at least a swimmer estimated to be in a first-drowning-state of drowning and sinking in water, and a swimmer estimated to be in a second-drowning-state involving a movement of the body, the second-drowning-state being a drowning state differing from the first-drowning-state. The swimmer estimated to be in the first-drowning-state may be referred to as a first-state swimmer. In addition, the swimmer estimated to be in the second-drowning-state may be referred to as a second-state swimmer.

The term “drowning” as used in the present specification means a state of drowning with water and choking due to the airway being blocked by water. Of drowning states that are states where a person drowns with water, a state where a person drowns and sinks in the water is referred to as a “first-drowning-state, ” and a state that is a drowning state differing from the first-drowning-state and involving a movement of the body of the person is referred to as a “second-drowning-state. ” Note that the “first-drowning-state” may involve a movement of the body as long as the person is in a state of drowning and sinking in the water. For example, a person in the first-drowning-state may move its body due to reaction such as convulsion.

In addition, the “first-drowning-state” can be defined as a state where a person drowns and loses consciousness, and the “second-drowning-state” can be defined as a drowning state before losing consciousness.

The “second-drowning-state” includes, for example, a state where a person performs a motion of hitting the surface of water or a motion such as climbing a ladder, and a state where the face of a person comes out of the surface of water and goes below the surface of water.

The detection information on an alert target swimmer indicates a status of detection of an alert target swimmer by the AI model for the inputted monitor image, and indicates the first-drowning-state and the second-drowning-state as a swimming state of the alert target swimmer in a distinguishable manner. Thus, this detection information may indicate whether or not either a swimmer in the first-drowning-state and a swimmer in the second-drowning-state is detected in the inputted monitor image or both the swimmer in the first-drowning-state and the swimmer in the second-drowning-state are detected, or may indicate the confidence level (probability value or the like) of the result of detection.

The detailed example described later gives an example in which the swimming-state information includes: the position where the alert target swimmer is detected in the monitor image; a state label that makes it possible to identify the swimming state of this alert target swimmer; and a numerical value (probability value) indicating the confidence level of the result of detection.

The AI model is trained by using training data including a plurality of pairs of a certain monitor image and ground truth information on the swimming-state information. The ground truth information on the swimming-state information can be obtained using annotations for the monitor image with which a pair is formed. However, as described above, the data structure of the AI model or the learning algorithm or the like is not limited.

The generating means generates drowning alert information on a swimmer on the basis of the swimming-state information acquired by the information acquiring means.

The “drowning alert information” represents information for prompting an alert to prevent a drowning accident before it happens, and is the source for instructing a means (a display device, an audio device, an illumination device, or the like) to make notification, the means finally notifying a user. For example, the drowning alert information includes a text, an image, sound, or the like.

However, the present embodiment does not limit specific details of the drowning alert information or the means that finally notifies a user.

In this manner, in a case of the present device, a monitor image obtained by capturing an aquatic location at a position higher than the surface of water is inputted into the AI model, and the drowning alert information on a swimmer is generated on the basis of the swimming-state information outputted from the AI model. In addition, the swimming-state information can include the detection information on an alert target swimmer in a manner such that the first-drowning-state and the second-drowning-state are distinguishable from each other. However, a monitor image captured from the underwater of the aquatic location may be included in the monitor image inputted into the AI model.

Thus, with the present device, it is possible to obtain the drowning alert information on a swimmer without imposing a load on the swimmer. In addition, the detection information on a swimmer in the second-drowning-state can be included in the swimming-state information outputted from the AI model so as to be distinguished from the first-drowning-state. Thus, it is possible to detect not only a swimmer who drowns and sinks in the water but also a swimmer in a state of moving the body and being struggling while drowning.

This makes it possible to use the drowning alert information to prompt an alert to rapidly detect a swimmer who moves its body and is struggling while drowning. In addition, it is possible to prevent a drowning accident in an aquatic location before it happens.

Below, swimmer monitoring systems according to two embodiments (first and second embodiments) will be given as details of the present embodiment, and the swimmer monitoring system according to each of the embodiments will be described.

### FIRST EMBODIMENT

### Swimmer Monitoring System

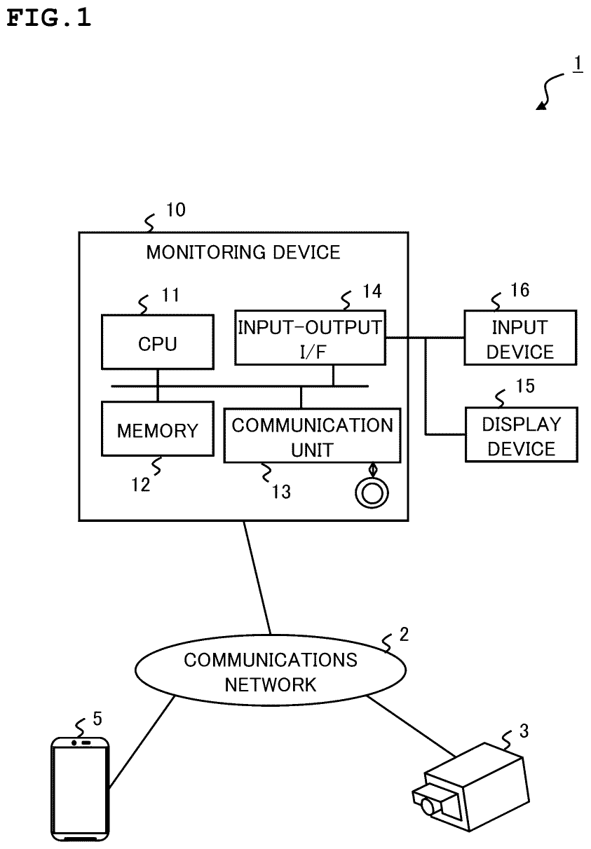

FIG. 1 is a diagram schematically illustrating an example of a hardware configuration of a swimmer monitoring system according to the first embodiment.

A swimmer monitoring system 1 according to the first embodiment includes a monitor camera 3, a user terminal 5, a monitoring device 10, and the like. The monitor camera 3, the user terminal 5, and the monitoring device 10 are each configured so as to be able to be coupled to a communications network 2.

The communications network 2 includes a public network such as the Internet, a wide area network (WAN), a local area network (LAN), a wireless communication network, and the like, and may be formed by a plurality of types of such communications networks or may be formed by one type of communications network. However, there is no limitation as to the communication scheme or communication protocol or the like of the communications network 2.

The monitor camera 3 is disposed at a position higher than the surface of water of the aquatic location serving as a monitoring target. The number of monitor cameras 3 may be one, or may be two or more. The monitor camera 3 according to the present embodiment is a wide-angle camera, and one monitor camera 3 images the entire aquatic location serving as a monitoring target. In addition, in a mode in which a plurality of monitor cameras 3 image the aquatic location serving as a monitoring target, the plurality of monitor cameras 3 is disposed such that image-capturing areas of individual cameras are set to regions (may include a portion of regions that overlap with each other) differing from each other.

The monitor camera 3 sequentially transmits the captured video signal (monitor image) to the monitoring device 10 in real time.

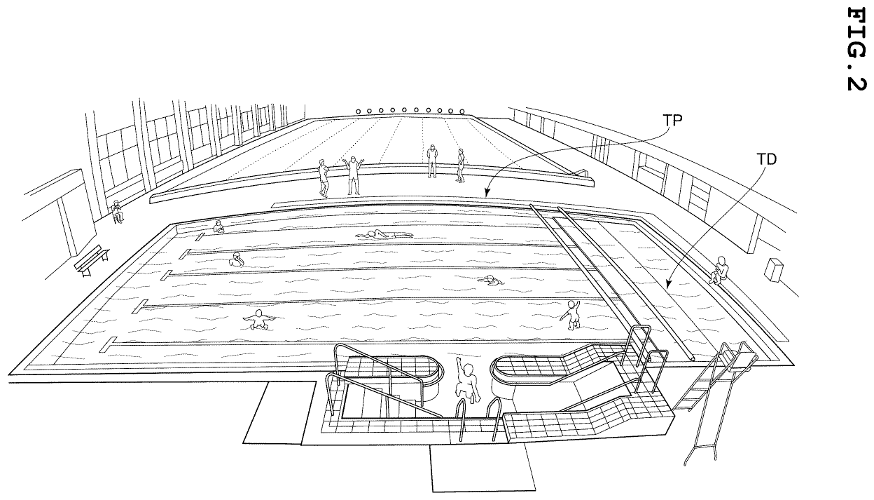

FIG. 2 is a diagram illustrating an example of a monitor image.

In the example of FIG. 2, a pool TP is the monitoring target, and the entire pool TP is imaged by the monitor camera 3 disposed at a position higher than the surface of water of the pool TP. In the example of FIG. 2, another pool is seen at the back (upper side of the drawing of FIG. 2) of the pool TP. However, the pool TP captured such that the surface of water is wider is set as the monitoring target.

In addition, a water-depth adjustment stage (pool platform) TD is disposed at the right side of the pool TP. The water depth at the location where the water-depth adjustment stage TD is disposed is shallower than other locations.

The user terminal 5 is a general mobile computer such as a laptop personal computer (PC), a mobile phone, a smartphone, or a tablet terminal. The user terminal 5 includes a CPU, a memory, a display unit, a communication unit, a microphone unit, a speaker unit, and the like, and can be coupled to the communications network 2 through wireless communication.

The user terminal 5 is coupled to the monitoring device 10 through the communications network 2 in a manner that they can communicate with each other, and receives the drowning alert information described above from the monitoring device 10. The user terminal 5 is owned by a user such as a person in charge of monitoring the aquatic location, and notifies the user of a drowning alert on the basis of the received drowning alert information. Details of this notification method will be described later.

### Monitoring Device

The monitoring device 10 serves as one specific example of the swimmer monitoring device described above, and is achieved by one computer in the present embodiment. The monitoring device 10 includes a central processing unit (CPU) 11, a memory 12, a communication unit 13, an input-output interface (I/F) 14, and the like that are coupled to each other through a bus, as illustrated in FIG. 1.

The CPU 11 is a so-called processor, and can also include an application-specific integrated circuit (ASIC), a digital signal processor (DSP), a graphics processing unit (GPU), and the like, in addition to a general CPU.

The memory 12 includes a random access memory (RAM), a read only memory (ROM), and an auxiliary storage device (hard disk or the like).

The communication unit 13 communicates with another computer through the communications network 2, and transmits or receives a signal with another device such as a printer, for example. In the present embodiment, the communication unit 13 receives a video signal from the monitor camera 3, and transmits the drowning alert information to the user terminal 5. In addition, the communication unit 13 can be coupled to a movable recording medium.

The input-output I/F 14 can be coupled to a user interface unit such as a display device 15, an input device 16, or the like. The display device 15 is a device configured to display a screen corresponding to drawing data processed by the CPU 11 or the like, and includes a liquid crystal display (LCD) or a cathode ray tube (CRT) display. The input device 16 is a device configured to receive input of a user operation, and includes a keyboard, a mouse, or the like. The display device 15 and the input device 16 may be configured as an integral unit, and be achieved as a touch panel.

The hardware configuration of the monitoring device 10 is not limited to the example of FIG. 1. The monitoring device 10 may include other hardware elements that are not illustrated, or may not include the display device 15 or the input device 16. In addition, the number of individual hardware elements is not limited to that in the example of FIG. 1. For example, the monitoring device 10 may include a plurality of CPUs 11. Furthermore, the monitoring device 10 may be achieved by a plurality of computers including a plurality of housings.

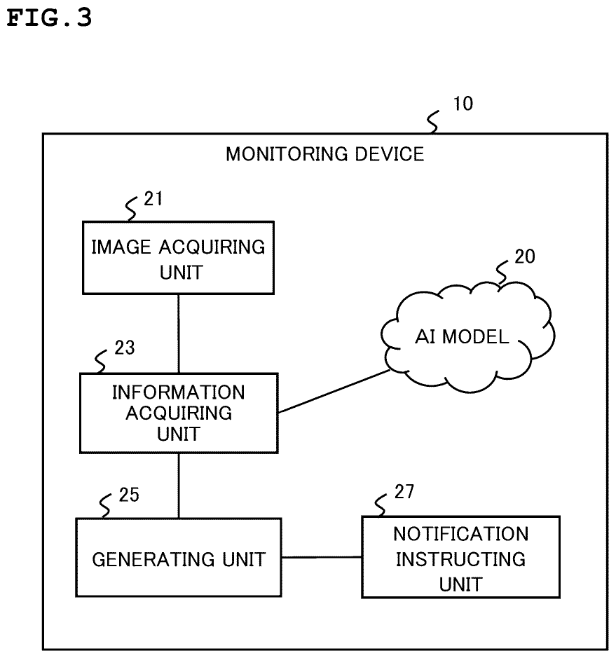

FIG. 3 is a diagram schematically illustrating an example of a configuration of software for the monitoring device 10 according to the first embodiment.

The monitoring device 10 includes an AI model 20, an image acquiring unit 21, an information acquiring unit 23, a generating unit 25, a notification instructing unit 27, and the like. These software elements are achieved by the CPU 11 executing a computer program held in the memory 12. For example, this computer program is installed from a movable recording medium such as a compact disc (CD), a memory, or the like, or from another device coupled to the communications network 2 through the communication unit 13, and is stored in the memory 12.

The AI model 20 is a learned model that uses the monitor image as input to output the swimming-state information.

The monitor image serving as the input is image data having a predetermined frame rate that has been determined in advance in accordance with the structure of the AI model 20, and in other words, is time-series image data including the predetermined number of pieces equal to or more than one piece per second in a video. The frame rate of the image data inputted into the AI model 20 is not limited as long as the AI model 20 can appropriately detect the swimming state. For example, this frame rate is equal to or more than 6 Fps (frames/sec) .

The AI model 20 in the first embodiment is configured such that the monitor image (one or more pieces of image, preferably, a plurality of pieces of consecutive images) as described above is used as the input, the first-drowning-state of a swimmer can be detected, and a plurality of types of individual motions as the second-drowning-state of the swimmer can be detected in a distinguishable manner.

The swimmer in the first-drowning-state has already been drowned and sunken in the water, and hence, is less likely to involve a movement. However, the swimmer in the second-drowning-state performs a motion of hitting the surface of water, a motion such as climbing a ladder, a motion in which the face goes up from the surface of water or goes below the surface of water, or the like, as a movement of the body while drowning.

With the first embodiment, it is possible to detect a plurality of types of individual motions as described above as the second-drowning-state in a distinguishable manner, which makes it possible to improve the accuracy of detection of a swimmer in the second-drowning-state.

In addition, the AI model 20 is configured so as to be able to distinguish and detect a plurality of types of individual motions as a dangerous motion that poses a risk that may result in a drowning state.

Here, the “dangerous motion” means a movement that does not yet reach the drowning state but poses a risk that may result in the drowning state. The dangerous motion includes a motion of moving while jumping up and down, a motion in which swimming swimmers are crossing each other, a motion of going underwater at or around a water-depth adjustment stage (pool platform) (reference character TD in FIG. 2), and the like. The motion of moving while jumping up and down is a motion performed by a swimmer who is in a state where his or her foot does not reach the bottom of water, and hence, this motion is a motion with which a risk of the swimmer starting drowning is high. It can be said that the other two motions are also motions with which the risk of starting drowning is high.

In addition to the first-drowning-state and the second-drowning-state, the first embodiment detects a plurality of types of dangerous motions as described above in a distinguishable manner. This makes it possible to accurately detect a swimmer in a dangerous state before starting drowning, which makes it possible to prevent a drowning accident before it happens.

However, the motion corresponding to the second-drowning-state that can be detected using the AI model 20 and the dangerous motion are not limited to the examples described above. Of the motions that can be detected using the AI model 20, a portion of these motions described above may be excluded, or other motions may be added.

The swimming-state information serving as the output includes the detection information on an alert target swimmer as described in the outline.

In the first embodiment, the alert target swimmer further includes a swimmer (also referred to as a dangerous-action swimmer) estimated to perform a dangerous motion that poses a risk that may result in the drowning state, in addition to the first-state swimmer and the second-state swimmer. Thus, it can be said that the swimming-state information in the first embodiment can include the detection information on the first-state swimmer, the second-state swimmer, and the dangerous-action swimmer in a manner such that the first-drowning-state, the second-drowning-state, and a state of performing the dangerous motion can be distinguished from each other.

In addition, in the first embodiment, the detection information on an alert target swimmer may include information that makes it possible to identify the first-drowning-state, a plurality of types of individual motions as the second-drowning-state, and a plurality of types of individual motions as the dangerous motion.

For example, as the information that makes it possible to identify individual motions or states, a label Al is attached to the motion of hitting the surface of water (second-drowning-state); a label A2 is attached to the motion such as climbing a ladder (second-drowning-state); a label A3 is attached to the motion in which a face or a head comes out of the surface of water and goes below the surface of water (second-drowning-state); a label A4 is attached to the first-drowning-state (state of drowning and sinking in the water); a label B1 is attached to the motion of moving while jumping up and down (dangerous motion); a label B2 is attached to the motion in which swimming swimmers are crossing each other (dangerous motion); and a label B3 is attached to the motion of going underwater at or around a water-depth adjustment stage (pool platform) (dangerous motion). In this example, a label corresponding to the detected motion or state is set in the detection information on an alert target swimmer.

However, even if no information that makes it possible to identify individual motions is attached, it may be possible to attach information that makes it possible to perform identification for each generic classification such as the first-drowning-state, the second-drowning-state, and the dangerous motion.

In this manner, in a case of the AI model 20 according to the first embodiment, by inputting consecutive image data including a plurality of pieces (monitor images) per second, it is possible to detect not only one still posture but also individual motions as described above. In addition, it is possible to distinguish a swimmer in the first-drowning-state, a swimmer in the second-drowning-state, and a swimmer doing the dangerous motion, and highly accurately detect them. In particular, for the motion of hitting the surface of water, the motion such as climbing a ladder, and the motion in which the face goes up from the surface of water or goes below the surface of water, each of which corresponds to the second-drowning-state, and the motion of moving while jumping up and down, which corresponds to the dangerous motion, it is possible to achieve detection by inputting consecutive image data including a plurality of pieces (monitor images) per second.

Furthermore, in the first embodiment, the detection information on an alert target swimmer may further include a probability value for each alert target swimmer.

This probability value represents a value indicating the degree (confidence level) of the probability that the swimming state or the motion of the alert target swimmer detected using the AI model 20 is correct. This probability value may be indicated in percentage, or may be indicated by a decimal fraction.

With this configuration, it is possible to easily recognize the credibility of detection for each alert target swimmer, and by using the index for determining whether or not the drowning alert information needs to be generated, it is possible to improve the confidence level of the drowning alert information itself.

In addition, in the first embodiment, the detection information on an alert target swimmer may further include image area information on an alert target swimmer within the monitor image for each alert target swimmer.

This image area information is information indicating an image area having a predetermined shape (rectangular shape, round shape, or the like) surrounding an alert target swimmer within the inputted monitor image, or an image area of the alert target swimmer itself. In a case where the image area information indicates an image area having the predetermined shape surrounding an alert target swimmer, this image area information is indicated as a group of pixel locations at the outer edge of this predetermined shape within the monitor image, for example. In addition, in a case where the image area information indicates an image area of the alert target swimmer itself, this image area information is indicated as a group of pixel locations indicating the alert target swimmer itself within the monitor image, for example.

With this configuration, it is possible to easily recognize the location of the alert target swimmer in a large aquatic location shown in the monitor image. This makes it easy to find the alert target swimmer, and also makes it possible to reliably prevent a drowning accident before it happens.

The AI model 20 is trained using training data including a plurality of pairs of a certain monitor image and ground truth information on the swimming-state information.

The ground truth information on the swimming-state information is generated on the basis of details of the swimming-state information determined as the output information of the AI model 20.

The ground truth information on the swimming-state information can be obtained using annotations for the monitor image with which a pair is formed, for example. Specifically, this ground truth information is generated so as to include the image area information concerning each alert target swimmer to be detected in the monitor image with which a pair is formed, information (label described above) that makes it possible to identify a swimming state or a swimming motion, and a probability value. In addition, in a mode in which the image area information and the probability value are not included in the swimming-state information, the ground truth information is generated so as to include information that makes it possible to identify a swimming state or a swimming motion of an alert target swimmer to be detected in the monitor image with which a pair is formed.

In addition, in a case where the monitor camera 3 is a wide-angle camera as described above, the monitor image inputted into the AI model 20 is a wide-angle image. A wide-angle image captured by a wide-angle camera includes distortion of an image. Furthermore, since the monitor image is captured from a position higher than the surface of water of the aquatic location, the surface of water captured in the monitor image shows the reflection of the illumination, the ceiling, the wall, or the like. The reflected item shown on the surface of water varies depending on locations of the surface of the water.

For this reason, it is preferable that the AI model 20 should be trained at least by using, as training data: a monitor image in which a swimmer in the first-drowning-state is shown in the middle area; a monitor image in which the swimmer in the first-drowning-state is shown in a first partial area; a monitor image in which the swimmer in the first-drowning-state is shown in a second partial area disposed at an opposite side of the middle area from the first partial area; a monitor image in which a swimmer performing each motion corresponding to the second-drowning-state is shown in the middle area; a monitor image in which the swimmer performing each motion corresponding to the second-drowning-state is shown in the first partial area; and a monitor image in which the swimmer performing each motion corresponding to the second-drowning-state is shown in the second partial area disposed at an opposite side of the middle area from the first partial area. More preferably, it is preferable that the AI model 20 should be further trained by using, as training data: a monitor image in which a swimmer performing each dangerous motion is shown in the middle area; a monitor image in which the swimmer performing each dangerous motion is shown in the first partial area; and a monitor image in which the swimmer performing each dangerous motion is shown in the second partial area at an opposite side of the middle area from the first partial area.

Here, the first partial area, the second partial area, and the middle area may be a left-side image area, a right-side image area, and a middle image area, or may be an upper-side image area, a lower-side image area, and a middle image area.

In this manner, by using, as training data, a plurality of monitor images in which swimmers who are in the same swimming state or are performing the same motion are shown but these swimmers exist in different image areas, it is possible to overcome a problem of distortion of a wide-angle image as described above and a problem resulting from a special monitoring target that is the surface of water in an aquatic location, and to enhance the accuracy of detection of a swimming state using the AI model 20.

However, as described above there is no limitation as to the data structure, the learning algorithm, or the like of the AI model 20.

Such an AI model 20 may be held in another device that can communicate with the monitoring device 10. In this case, the monitoring device 10 can access the AI model 20 held in the other device through communication.

The image acquiring unit 21 acquires a monitor image captured by the monitor camera 3. Specifically, once the communication unit 13 receives a video signal sequentially transmitted from the monitor camera 3, the image acquiring unit 21 acquires, from the received video signal, image data of a monitor image at a predetermined frame rate.

In a case of training and building the AI model 20 by using, as input, the frame rate of the video signal received from the monitor camera 3, the image acquiring unit 21 acquires consecutive image data with this frame rate of the video signal. However, in a case of training and building the AI model 20 by using, as input, consecutive image data having a predetermined frame rate lower than the frame rate of the video signal, the image acquiring unit 21 may acquire consecutive image data having the predetermined frame rate described above lower than the frame rate of the video signal.

There is no limitation as to the method of acquiring a monitor image by the image acquiring unit 21. The image acquiring unit 21 serves as one specific example of the image acquiring means described in the outline.

The information acquiring unit 23 inputs, into the AI model 20, image data of the monitor image acquired by the image acquiring unit 21 to acquire the swimming-state information outputted from the AI model 20. The information acquiring unit 23 serves as one specific example of the information acquiring means described in the outline.

It is preferable that a monitor image inputted into the AI model 20 should be image data having a predetermined frame rate that has been determined in advance in accordance with the specifications (the structure or training data that is used, or the like) of the AI model 20 as described above.

For example, in a case of the AI model 20 having specifications in which consecutive image data having a frame rate of 6 Fps (frames/sec) is inputted, it is preferable to employ a configuration in which the image acquiring unit 21 acquires image data of a monitor image at a frame rate of 6 Fps, and the information acquiring unit 23 inputs the image data of the frame rate of 6 Fps into the AI model 20. In addition, in a case of the AI model 20 having specifications in which consecutive image data having a frame rate of 30 Fps (frames/sec) is inputted, it is similarly preferable to employ a configuration in which the image acquiring unit 21 acquires image data of a monitor image at a frame rate of 30 Fps, and the information acquiring unit 23 inputs the image data of the frame rate of 30 Fps into the AI model 20.

The generating unit 25 generates the drowning alert information on a swimmer on the basis of the swimming-state information acquired by the information acquiring unit 23 from the AI model 20. The generating unit 25 serves as one specific example of the generating means described in the outline.

In a case where the swimming-state information indicates detection of an alert target swimmer, the generating unit 25 generates the drowning alert information. For example, in a case where the swimming-state information includes a label of the first-drowning-state, a label of a motion corresponding to the second-drowning-state, or a label of the dangerous motion, the generating unit 25 may generate the drowning alert information. In addition, in a mode in which the swimming-state information includes a probability value for each alert target swimmer, the generating unit 25 may determine whether or not to generate the drowning alert information, on the basis of the probability value included in the detection information of the swimming-state information. In this case, in a case where a probability value exceeding a predetermined threshold value is included in the swimming-state information, the generating unit 25 generates the drowning alert information.

Furthermore, in a mode in which the swimming-state information includes the image area information on an alert target swimmer, the generating unit 25 may generate the drowning alert information including a monitor image in which an image area for one or more alert target swimmers is designated, on the basis of the image area information.

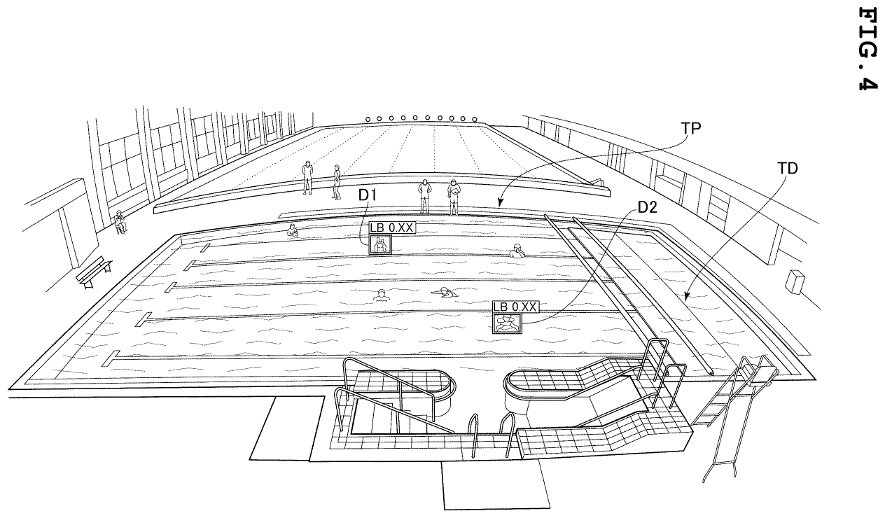

FIG. 4 is a diagram illustrating an example of a monitor image included in the drowning alert information.

In the example of FIG. 4, six swimmers exist in a pool TP, and two people of them are detected as alert target swimmers. In this case, for example, the swimming-state information includes the image area information, a label that makes it possible to identify a motion or a state, and a probability value for each of these two alert target swimmers.

In the monitor image included in the drowning alert information, rectangular frames D1 and D2 that each surround the alert target swimmer are superimposed on the basis of the image area information on the alert target swimmers. In addition, labels (illustrated as “LB” in FIG. 3) indicating a state or a motion of the alert target swimmer and probability values (illustrated as “0.XX” in FIG. 3) are shown at the upper side in the rectangular frames D1 and D2.

Thus, with the rectangular frames D1 and D2 being displayed, it is possible to easily recognize the location of the alert target swimmer from among a plurality of swimmers. In addition, with the labels being displayed, it is possible to easily recognize a state or a motion of the alert target swimmer. Furthermore, with the probability values being displayed, it is possible to recognize the credibility of the detection information.

This makes it easy to find an alert target swimmer, and also makes it possible to reliably prevent a drowning accident before it happens.

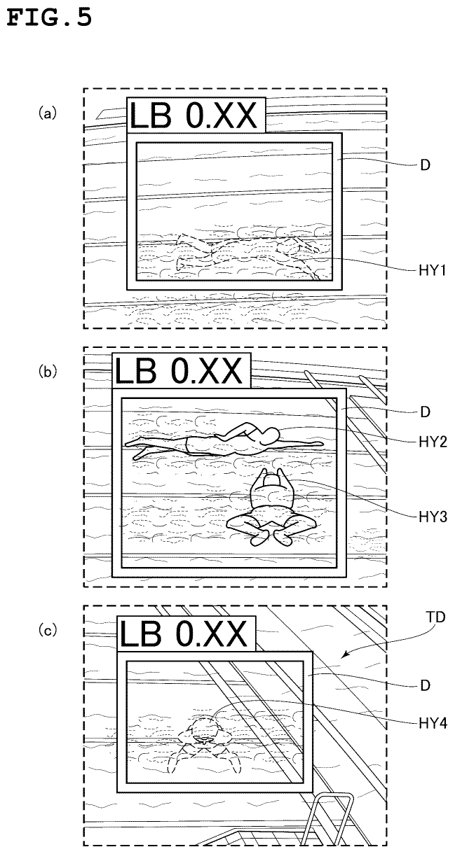

FIG. 5 is a diagram illustrating examples of detection information on an alert target swimmer in various types of swimming states.

More specifically, FIG. 5(a) illustrates an example of the detection information on a first-state swimmer estimated to be in the first-drowning-state. FIG. 5(b) illustrates an example of the detection information on a dangerous-action swimmer estimated to perform one type (motion in which swimming swimmers are crossing each other) of dangerous motion. FIG. 5(c) illustrates an example of the detection information on a dangerous-action swimmer estimated to perform one type (motion of going underwater at or around a water-depth adjustment stage TD) of dangerous motion. In addition, each of the diagrams of FIG. 5 shows the rectangular-shape frame D surrounding an image area of an alert target swimmer, a label (LB) for identifying a state or a motion detected concerning this alert target swimmer, and a probability value (0.XX).

FIG. 5(a) illustrates the rectangular-shape frame D so as to surround a swimmer HY1 estimated to be in the first-drowning-state of drowning and sinking in the water. FIG. 5(b) illustrates the rectangular-shape frame D so as to surround a swimmer HY2 and a swimmer HY3 estimated to be in a state of crossing each other. FIG. 5(c) illustrates the rectangular-shape frame D so as to surround a swimmer HY4 estimated to go underwater near the water-depth adjustment stage TD.

The notification instructing unit 27 gives a predetermined notifying means (notifying unit) an instruction to make notification of a drowning alert in a case where the drowning alert information is generated by the generating unit 25.

In the first embodiment, the notification instructing unit 27 transmits the drowning alert information generated by the generating unit 25 to the user terminal 5. The user terminal 5 makes notification of the drowning alert on the basis of the received drowning alert information. The user terminal 5 is able to display a monitor image and text information included in the drowning alert information as a notification of the drowning alert.

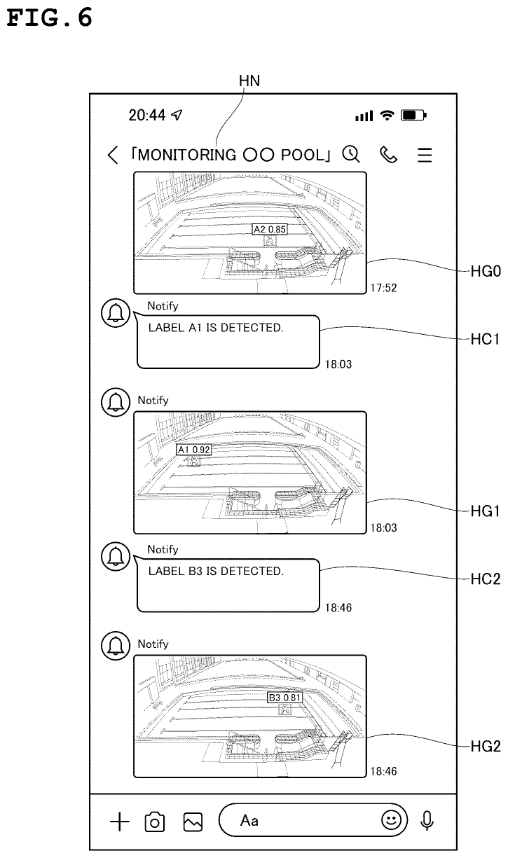

FIG. 6 is a diagram illustrating an example of a drowning-alert notification screen displayed on the user terminal 5.

In the screen illustrated in FIG. 6 as an example, a monitoring name HN “Monitoring oo pool” is shown in the upper section, and notice messages HC1 and HC2 as well as notification monitor images HG0, HG1, and HG2 are shown together with the time.

For example, a pair of the notice message HC1 and the notification monitor image HG1 and a pair of the notice message HC2 and the notification monitor image HG2 are generated on the basis of the monitor image, text information, and the like included in the drowning alert information generated by the generating unit 25. The notice message HC1 indicates that the label (A1) that makes it possible to identify a certain motion corresponding to the second-drowning-state is detected. The notification monitor image HG1 that is paired with the notice message HC1 displays the label (A1) and the probability value (0.92) together with the rectangular-shape frame surrounding the detected alert target swimmer in a superimposed manner. The notice message HC2 indicates that the label (B3) that makes it possible to identify a certain dangerous motion is detected. The notification monitor image HG2 that is paired with the notice message HC2 displays the label (B3) and the probability value (0.81) together with the rectangular-shape frame surrounding the detected alert target swimmer in a superimposed manner.

Such a notification screen enables a user such as a lifeguard to recognize a state or a motion of the alert target swimmer through the notice message. In addition, the notification monitor image makes it possible to immediately recognize the location of the alert target swimmer. Thus, on the basis of the information on this notification screen, the user such as a lifeguard can immediately check the safety or take action such as rescue by actually visually recognizing the aquatic location.

Here, although illustration is not given in FIG. 6, the color of the rectangular-shape frame surrounding an alert target swimmer or the color of a label or a probability value may be controlled so as to differ in accordance with the probability value or the label. For example, in a case where the probability value exceeds a predetermined value, they may be colored in a color (for example, red) that indicates dangerous, and in other cases, they may be colored in a color (for example, yellow) that indicates caution. In addition, the color of the rectangular-shape frame surrounding an alert target swimmer or the color of a label or a probability value may be controlled so as to differ between a case where the label is A1, A2, or A3 and a case where the label is B1, B2, or B3.

However, the method of notifying a drowning alert is not limited to the example of the screen described above.

For example, the notification instructing unit 27 may be configured to read and play audio data held in the memory 12 to cause a speaker (not illustrated) coupled to the input-output I/F 14 to output the sound, whereby the monitoring device 10 itself makes notification of a drowning alert. In addition, in place of or in addition to the screen illustrated in FIG. 6 as an example, the user terminal 5 may output sound.

Furthermore, on the basis of the drowning alert information generated by the generating unit 25, it is possible to make notification of a drowning alert even with other outputting means.

### Swimmer Monitoring Method

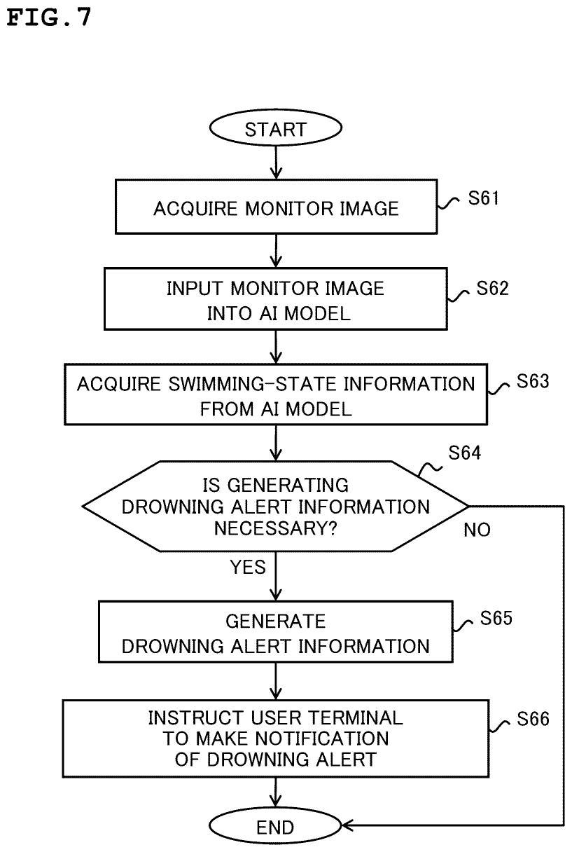

Next, a swimmer monitoring method according to the first embodiment will be described with reference to FIG. 7.

FIG. 7 is a flowchart indicative of an example of operations of the monitoring device 10 according to the first embodiment.

The swimmer monitoring method according to the first embodiment is performed by the monitoring device 10, and individual steps of this method are performed by individual software elements described above that the monitoring device 10 includes. Thus, specific details of each of the steps are similar to details of processes of each of the software elements described above, and details of each of the steps will not be repeated on an as-necessary basis. In addition, the swimmer monitoring method can be expressed as being able to be performed by one or more computers (CPU 11) such as the monitoring device 10 capable of utilizing the AI model 20. Furthermore, each of the steps in the swimmer monitoring method can be expressed as being able to be performed by the one or more computers (CPU 11).

The swimmer monitoring method according to the first embodiment includes at least step (S61), step (S62), step (S63), step (S64), step (S65), and step (S66) as illustrated in FIG. 7. Each of the steps illustrated in FIG. 7 is repeatedly performed every time image data of a monitor image to be inputted into the AI model 20 is acquired in step (S61).

In step (S61), the CPU 11 sequentially acquires a monitor image captured by the monitor camera 3. Details of the acquired monitor image and the method of acquiring the monitor image have already been described for the image acquiring unit 21.

In step (S62) and step (S63), the CPU 11 inputs image data of the monitor image acquired in step (S61) into the AI model 20 (S62), and acquires the swimming-state information outputted from the AI model 20 (S63). Details of the AI model 20 have already been described above. Details of a monitor image to be inputted into the AI model 20 and details of the swimming-state information outputted from the AI model 20 have also already been described in connection with the information acquiring unit 23.

In step (S64), the CPU 11 determines whether or not to generate the drowning alert information on the basis of the swimming-state information acquired in step (S63). Various methods can be used to make this determination as described in connection with the generating unit 25. For example, in a case where a label of the first-drowning-state, a label of a motion corresponding to the second-drowning-state, or a label of a dangerous motion is included in the swimming-state information, the CPU 11 may determine to generate the drowning alert information. In addition, in a case where the probability value included in the swimming-state information exceeds a predetermined threshold value that is set in advance, the CPU 11 may determine to generate the drowning alert information.

In step (S65), in a case where it is determined to generate the drowning alert information (S64; YES), the CPU 11 generates the drowning alert information on the basis of the swimming-state information acquired in step (S63). Details of the drowning alert information and the method of generating the drowning alert information have already been described in connection with the generating unit 25.

In step (S66), the CPU 11 transmits, to the user terminal 5, the drowning alert information generated in step (S65) to instruct the user terminal 5 to make notification of the drowning alert. Details of step (S66) have already been described in connection with the notification instructing unit 27. In response to this instruction, for example, the user terminal 5 displays a screen as illustrated in FIG. 6 as an example, thereby notifying a user to carefully monitor drowning of a swimmer.

### SECOND EMBODIMENT

Below, a swimmer monitoring system according to a second embodiment will be described with focus being placed on details differing from the first embodiment. In the following description, details similar to those in the first embodiment will not be repeated as appropriate.

The second embodiment differs from the first embodiment in that the AI model 20 is able to detect an alert target swimmer with a float and an alert target swimmer without a float in an inputted monitor image so as to distinguish these alert target swimmers from each other. The swimmer monitoring system according to the second embodiment may include the hardware configurations (see FIG. 1) and the software configurations (see FIG. 3) similar to those in the first embodiment, and these configurations are not limited as in the first embodiment.

The AI model 20 according to the second embodiment is configured to be able to detect an alert target swimmer with a float and an alert target swimmer without a float in a distinct manner, using the same monitor image as in the first embodiment as input.

The “float” as used here means an item for a swimmer to float on the surface of water and be used. The float includes a swim float, a boat, a floating mat, an animal-type or character-type float, or the like.

The “alert target swimmer with a float” means an alert target swimmer estimated to use a float, and is detected as an alert target swimmer existing on or below or near the float.

The alert target swimmer without a float is detected in a manner similar to that in the first embodiment. That is, as in the first embodiment, the AI model 20 is configured so as to be able to detect a first-state swimmer estimated to be in the first-drowning-state, a second-state swimmer estimated to be in the second-drowning-state, and a dangerous-action swimmer estimated to perform a dangerous motion, as an alert target swimmer without a float.

In addition, the swimming-state information outputted from the AI model 20 can include the following detection information on an alert target swimmer. That is, this detection information further includes information that makes it possible to distinguish the alert target swimmer with a float and the alert target swimmer without a float. For example, a label (F) indicating having a float is attached to the alert target swimmer with a float whereas this label is not attached to the alert target swimmer without a float.

A motion corresponding to the second-drowning-state or the dangerous motion differs depending on whether or not a float is used. By making it possible to distinguish and detect an alert target swimmer on the basis of whether or not a float is used in this manner, it is possible to appropriately detect the second-drowning-state and the dangerous motion of a swimmer who enjoys in a various manner.

In connection with the swimmer with a float, the AI model 20 according to the second embodiment is configured so as to be able to detect one type of motion as the second-drowning-state and also be able to detect one type of dangerous motion.

As for the motion corresponding to the second-drowning-state for a swimmer with a float, it is possible to detect a motion in which the float turns upside down. In addition, as for the dangerous motion for a swimmer with a float, it is possible to detect a motion (state) in which a swimmer exists under the float.

Furthermore, the detection information on an alert target swimmer in the swimming-state information outputted from the AI model 20 further includes information that makes it possible to identify each of a motion as the second-drowning-state and the dangerous motion regarding an alert target swimmer with a float. For example, a label F Al is attached to a motion, in which the float turns upside down, as the second-drowning-state, and a label F B1 is attached to a motion (state), in which a swimmer exists under the float, as the dangerous motion.

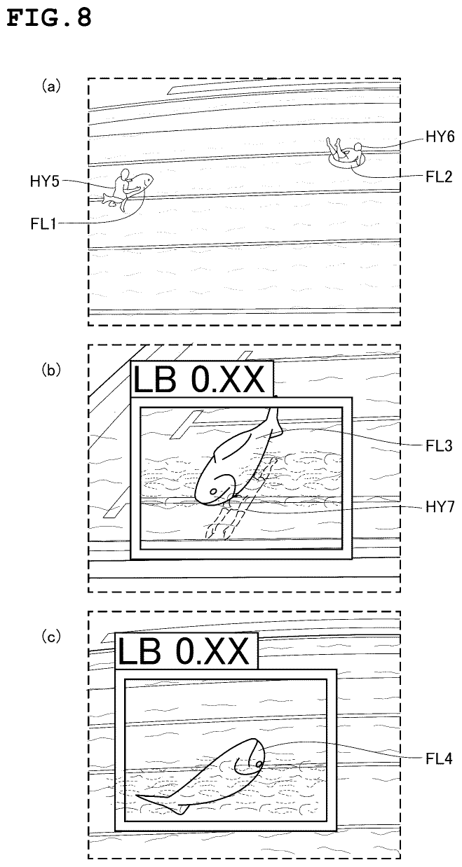

FIG. 8 is a diagram illustrating an example of various types of swimming states of swimmers with a float.

More specifically, FIG. 8(a) illustrates an example of a normal swimmer with a float shown in a monitor image. FIG. 8(b) illustrates an example of detection information on a dangerous-action swimmer with a float estimated to perform a dangerous motion (motion of existing under the float). FIG. 8(c) illustrates an example of detection information on a second-state swimmer with a float estimated to perform one type of motion (motion in which the float turns upside down) as the second-drowning-state.

FIG. 8(a) illustrates a swimmer HY5 riding on an animal-type float FL1 and a swimmer HY6 riding on a float (swim float) FL2. The swimmers HY5 and HY6 with a float illustrated in FIG. 8(a) are swimmers in a normal state that does not correspond to any of the first-drowning-state, the second-drowning-state, or the state of performing a dangerous motion, and hence, are not detected as an alert target swimmer.

On the other hand, FIG. 8(b) and 8(c) each illustrate a rectangular-shape frame D surrounding an image area of an alert target swimmer with a float, a label (LB) that identifies a state or a motion detected in connection with the alert target swimmer with a float, and a probability value (0.XX). Specifically, in FIG. 8(b), a rectangular-shape frame is shown so as to surround a swimmer HY7 estimated to exist under a float FL3 and the float FL3. In FIG. 8(c), a rectangular-shape frame is shown so as to surround a float FL4 that has turned upside down and splashing water around the float FL4.

In this manner, the motion of the second-drowning-state that can be detected in connection with a swimmer with a float and the motion (motion of hitting the surface of water or the like) of the second-drowning-state that can be detected in connection with a swimmer without a float differ from each other. That is, it can be expressed that the AI model 20 makes it possible to detect motions that differ from each other between the second-drowning-state of the second-state swimmer with a float and the second-drowning-state of the second-state swimmer without a float.

However, in connection with a swimmer with a float, the AI model 20 may be configured so as to be able to detect a plurality of types of motions as the second-drowning-state and a plurality of types of dangerous motions. In addition, for a swimmer with a float, it may be possible to detect a motion other than the motions described above.

In training data used to train the AI model 20 as described above, an alert target swimmer with a float and an alert target swimmer without a float are distinguished to perform annotation for a monitor image.

As for the motion in which the float turns upside down as the second-drowning-state, the annotation is performed for a state where the float stands at 90° relative to the surface of water in a series of image data of monitor images serving as a unit of input. This is a method obtained after repeated technical trials by the present inventor to make it possible for the AI model 20 to detect the motion in which the float turns upside down.

### THIRD EMBODIMENT

Below, a swimmer monitoring system according to a third embodiment will be described with focus being placed on details differing from the first embodiment and the second embodiment. In the following description, details similar to those in the first embodiment and the second embodiment will not be repeated as appropriate.

The swimmer monitoring system according to the third embodiment may include the hardware configurations (see FIG. 1) and the software configurations (see FIG. 3) similar to those in the first embodiment and the second embodiment, and there is no limitation as to these configurations, as in the first embodiment and the second embodiment.

Each of the embodiments described above gives, as an example, the “first-drowning-state” and the “second-drowning-state” as the drowning state that is a state where a person drowns in the water. However, in the third embodiment, the drowning state is treated by further distinguishing a “third-drowning-state” of drowning and floating with the face being below the surface of water, in addition to the “first-drowning-state” and the “second-drowning-state.”

The “third-drowning-state” can be expressed as a prone-float state. It is known that there is a possibility that, due to drowning, a laryngospasm occurs and a glottis closes, resulting in a prone-float state. Thus, the “third-drowning-state” can be defined as a state where a person drowns and loses consciousness, as in the first-drowning-state.

In the third embodiment, the “second-drowning-state” is a drowning state differing from the first-drowning-state and the third-drowning-state, and is defined as a drowning state involving a movement of the body.

The AI model 20 according to the third embodiment uses, as input, a monitor image similar to that in each of the embodiments described above, and is built such that the third-drowning-state of a swimmer can be detected, in addition to the states or the motions of a swimmer as described above. A swimmer that is in the third-drowning-state is less likely to involve a movement of the body other than a small movement such as a spasm due to the swimmer being in a state of drowning and floating with the face being below the surface of water.

Furthermore, in addition to the first-state swimmer estimated to be in the first-drowning-state and the second-state swimmer estimated to be in the second-drowning-state, the swimming-state information outputted from the AI model 20 can include the detection information on a third-state swimmer (alert target swimmer) estimated to be in the third-drowning-state that is a prone-float state, in a manner such that the first-drowning-state, the second-drowning-state, and the third-drowning-state can be distinguished from each other. For example, a label A5 is attached to the third-drowning-state (prone-float state) in the detection information on an alert target swimmer in the swimming-state information.

In the training data used to train the AI model 20 as described above, not only the first-state swimmer, the second-state swimmer, the dangerous-action swimmer, the alert target swimmer with a float, and the alert target swimmer without a float but also the third-state swimmer in the third-drowning-state is further distinguished to perform annotation for a monitor image. In addition to the monitor image in each of the embodiments described above, it is preferable that the AI model 20 should be further trained by using, as training data: a monitor image in which a swimmer in the third-drowning-state is shown in the middle area; a monitor image in which the swimmer in the third-drowning-state is shown in the first partial area; and a monitor image in which the swimmer in the third-drowning-state is shown in the second partial area at an opposite side of the middle area from the first partial area.

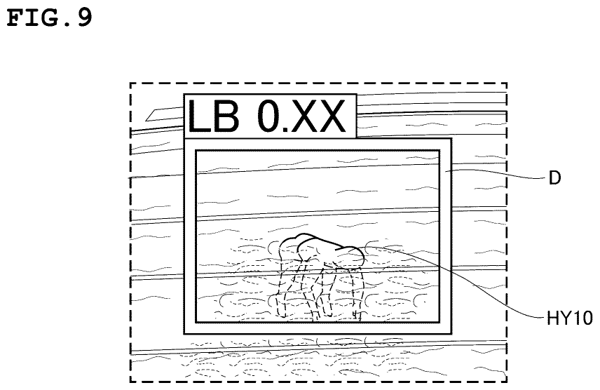

FIG. 9 is a diagram illustrating an example of the detection information on a third-state swimmer (alert target swimmer) estimated to be in the third-drowning-state.

FIG. 9 illustrates a rectangular-shape frame D so as to surround a third-state swimmer HY10 estimated to be in the third-drowning-state that is the state of drowning and floating with the face being below the surface water. In addition, as in FIG. 5 or the like, FIG. 9 illustrates a label (LB) that identifies the third-drowning-state detected in connection with the third-state swimmer (alert target swimmer), and a probability value (0.XX). For example, A5 is shown as a label that identifies the third-drowning-state.

The generating unit 25 generates the drowning alert information on a swimmer on the basis of such swimming-state information acquired by the information acquiring unit 23 from the AI model 20.

The generating unit 25 may generate the drowning alert information in a case where a label of the first-drowning-state or the third-drowning-state, or a label of a motion corresponding to the second-drowning-state or the dangerous motion is included in the swimming-state information, for example. In addition, in a mode in which a probability value for each alert target swimmer is included in the swimming-state information, the generating unit 25 may determine whether or not to generate the drowning alert information on the basis of the probability value included in the detection information of the swimming-state information.

With the third embodiment as described above, it is possible to not only detect a swimmer in the first-drowning-state of having already sunken but also a swimmer estimated to be in the third-drowning-state that is the prone-float state as a state where there is almost no movement of the body due to drowning, so as to be able to be distinguished from the other drowning states.

### Modification Example

It is possible to modify details of each of the embodiments described above on an as-necessary basis as long as the modification falls within the main points.

For example, the AI model 20 described above may be built such that the swimming-state information serving as output includes detection information on all swimmers including a swimmer in a normal state in addition to the alert target swimmer.

In this case, a state (normal state) that does not belong to any states of the first-drowning-state, the second-drowning-state, the third-drowning-state and a state of performing a dangerous motion is provided with information (a state label) that makes it possible to identify it from other states, and the detection information includes image area information in a monitor image, the state label indicating the normal state, and a probability value for each swimmer in the normal state.

In addition, in the embodiments described above, the drowning alert information is generated in a case where the detection of an alert target swimmer is indicated in the swimming-state information outputted from the AI model 20. However, the drowning alert information may be always generated when the swimming-state information is acquired from the AI model 20.

In this case, the notification instructing unit 27 may determine whether or not to make notification of a drowning alert on the basis of the thus generated drowning alert information, or it may be possible to employ a configuration in which a device (means) side such as the user terminal 5 that makes notification determines whether or not to make this notification.

Furthermore, it may be possible to employ a configuration in which the user terminal 5 displays detection information concerning all swimmers from the AI model 20, and a user who views this display finds the alert target swimmer in this display. In this case, the user terminal 5 may change a color of the rectangular-shape frame or a color of display of the label between swimmers in the normal state and other swimmers.

In addition, although no particular statement is made in each of the embodiments described above, the monitor camera 3 may include a camera that captures the underwater of an aquatic location, and a monitor image inputted into the AI model 20 includes a monitor image obtained by capturing the underwater of an aquatic location.

In this case, the AI model 20 may be trained by using an underwater monitor image in addition to the monitor images captured from a position higher than the surface of water, and the same annotation may be performed for the underwater monitor image.

Below, by using Examples, the embodiments described above will be described more in detail.

By using a swimmer monitoring system (hereinafter, referred to as an Example system) corresponding to the first embodiment described above, a demonstration experiment concerning monitoring a swimmer was conducted in a certain indoor pool, and the result of this experiment will be described below as Examples. However, from the following Examples, there is no limitation imposed on the present invention.

### EXAMPLE

The indoor pool serving as a monitoring target has an area of 10 m×20 m. In the Example system, one monitor camera 3 is installed so as to be able to image the entire indoor pool from above. On the basis of a video signal from this monitor camera 3, consecutive image data having a frame rate of 6 Fps (frames/sec) is acquired as a monitor image to be inputted into the AI model 20.

In the present example, the AI model 20 is built such that a monitor image having a frame rate of 6 Fps is used as input as described above, and the swimming-state information including the detection information on an alert target swimmer as described below is outputted.

The detection information on an alert target swimmer according to the present example includes labels that each make it possible to identify a motion of hitting the surface of water (second-drowning-state); a motion such as climbing a ladder (second-drowning-state); a motion in which the head comes out of the surface of water and goes below the surface of water (second-drowning-state); the first-drowning-state of drowning and sinking in the water; a motion of moving while jumping up and down (dangerous motion); a motion in which swimming swimmers are crossing each other (dangerous motion); and a motion of going underwater at or around a water-depth adjustment stage (pool platform) (dangerous motion).

The AI model 20 is trained by using the monitor images described above and acquired for the purpose of training. Specifically, 26,681 pieces of image data that each include five to ten swimmers shown therein was used as the training data.

In addition, for the AI model 20 that has been trained in this manner, the accuracy of detection was examined by using the monitor images described above and acquired for the purpose of examination. For the examination, 6,682 pieces of image data that each include five to ten swimmers shown therein was used.

Values indicating the accuracy of detection of the AI model 20 result in the following values.

Precision=96.0%

Recall=95.7%

Harmonic mean (F measure) of precision and recall=0.96

The precision indicates a ratio of correct detection relative to the detection target, and is calculated through “correctly detected instances/all detected instances.”

The recall indicates a ratio of correct detection relative to all detection target data, and is calculated through “correctly detected instances/all correct instances.”

In this manner, with the present example, it is demonstrated that, by using the AI model 20, it is possible to highly accurately detect a swimmer in the first-drowning-state, a swimmer in the second-drowning-state, and a swimmer who performs a dangerous motion. In addition, it can be said that, with the Example system, it is demonstrated that it is possible to prevent a drowning accident before it happens without imposing a load on the swimmer.

A portion of or all of each of the embodiments and the modification example described above can be specified in the following Notes. However, each of the embodiments and the modification example should not be limited to the following description.

### Note 1

A swimmer monitoring device including:
an image acquiring means configured to acquire a monitor image obtained by capturing an aquatic location from a position higher than a surface of water;
an information acquiring means configured to acquire swimming-state information outputted from a learned model by inputting the acquired monitor image into the learned model; and
a generating means configured to generate drowning alert information on a swimmer on a basis of the acquired swimming-state information, in which
the swimming-state information can include detection information on an alert target swimmer in such a manner as to enable a first-drowning-state and a second-drowning-state to be distinguished from each other, the first-drowning-state being a state of drowning and sinking in water, a second-drowning-state involving a movement of a body and being differing from the first-drowning-state, the alert target swimmer including at least a first-state swimmer estimated to be in the first-drowning-state and a second-state swimmer estimated to be in the second-drowning-state.

### Note 2

The swimmer monitoring device according to Note 1, in which
the learned model is capable of distinguishing and detecting each of plural types of individual motions as the second-drowning-state in the monitor image, and
the detection information that can be included in the swimming-state information can include information that makes it possible to identify each of the plural types of individual motions as the second-drowning-state.

### Note 3

The swimmer monitoring device according to Note 1 or 2, in which
the learned model is capable of distinguishing and detecting each of plural types of individual motions as a dangerous motion that poses a risk that possibly results in a drowning state in the monitor image,
the alert target swimmer indicated by the detection information that can be included in the swimming-state information further includes a dangerous-action swimmer estimated to perform the dangerous motion, and
the detection information that can be included in the swimming-state information can include information that makes it possible to identify each of the plural types of individual motions as the dangerous motion.

### Note 4

The swimmer monitoring device according to any one of Notes 1 to 3, in which
the swimming-state information can include the detection information on the alert target swimmer in such a manner as to enable the first-drowning-state, the second-drowning-state and a third-drowning-state to be distinguished from each other, the third-drowning-state being a state of drowning and floating with a face being below a surface of water, the alert target swimmer including the first-state swimmer and the second-state swimmer and further including a third-state swimmer estimated to be in the third-drowning-state.

### Note 5

The swimmer monitoring device according to any one of Notes 1 to 4, in which
the detection information that can be included in the swimming-state information further includes a probability value for each of the alert target swimmer, and
the generating means determines whether or not to generate the drowning alert information on a basis of the probability value included in the detection information of the swimming-state information.

### Note 6

The swimmer monitoring device according to any one of Notes 1 to 5, in which
the detection information that can be included in the swimming-state information further includes image area information on the alert target swimmer in the monitor image for each of the alert target swimmer, and
the generating means generates the drowning alert information including a monitor image in which an image area of one or a plurality of the alert target swimmers is designated, on a basis of the image area information included in the detection information of the swimming-state information.

### Note 7

The swimmer monitoring device according to any one of Notes 1 to 6, in Which
the learned model makes is capable of distinguishing and detecting the alert target swimmer with a float and the alert target swimmer without a float in the monitor image, and
the detection information that can be included in the swimming-state information further includes information that makes it possible to distinguish the alert target swimmer with a float and the alert target swimmer without a float.

### Note 8

The swimmer monitoring device according to Note 7, in which
the learned model is capable of detecting motions, in the monitor image, that differ from each other between the second-drowning-state of the second-state swimmer with a float and the second-drowning-state of the second-state swimmer without a float.

### Note 9

The swimmer monitoring device according to any one of Notes 1 to 8, in which
the monitor image acquired by the image acquiring means is a wide-angle image captured by a wide-angle camera, and
the learned model is trained at least by using, as training data:
   the monitor image in which a swimmer in the first-drowning-state is shown in a middle area;
   the monitor image in which the swimmer in the first-drowning-state is shown in a first partial area;
   the monitor image in which the swimmer in the first-drowning-state is shown in a second partial area disposed at an opposite side of the middle area from the first partial area;
   the monitor image in which a swimmer in the second-drowning-state is shown in the middle area;
   the monitor image in which the swimmer in the second-drowning-state is shown in the first partial area; and
   the monitor image in which the swimmer in the second-drowning-state is shown in the second partial area.

### Note 10

The swimmer monitoring device according to Note 4, in which
the monitor image acquired by the image acquiring means is a wide-angle image captured by a wide-angle camera, and
the learned model is trained at least by using, as training data:
   the monitor image in which a swimmer in the first-drowning-state is shown in a middle area;
   the monitor image in which the swimmer in the first-drowning-state is shown in a first partial area;
   the monitor image in which the swimmer in the first-drowning-state is shown in a second partial area disposed at an opposite side of the middle area from the first partial area;
   the monitor image in which a swimmer in the second-drowning-state is shown in the middle area;
   the monitor image in which the swimmer in the second-drowning-state is shown in the first partial area;
   the monitor image in which the swimmer in the second-drowning-state is shown in the second partial area;
   the monitor image in which a swimmer in the third-drowning-state is shown in the middle area;
   the monitor image in which the swimmer in the third-drowning-state is shown in the first partial area; and
   the monitor image in which the swimmer in the third-drowning-state is shown in the second partial area.

### Note 11

A swimmer monitoring method, in which one or more processors capable of using a learned model execute:
a step of acquiring a monitor image obtained by capturing an aquatic location from a position higher than a surface of water;
a step of acquiring swimming-state information outputted from the learned model by inputting the acquired monitor image into the learned model; and
a generating step of generating drowning alert information on a swimmer on a basis of the acquired swimming-state information, in which
the swimming-state information can include detection information on an alert target swimmer in such a manner as to enable a first-drowning-state and a second-drowning-state to be distinguished from each other, the first-drowning-state being a state of drowning and sinking in water, a second-drowning-state involving a movement of a body and being differing from the first-drowning-state, the alert target swimmer including at least a first-state swimmer estimated to be in the first-drowning-state and a second-state swimmer estimated to be in the second-drowning-state.

### Note 12

The swimmer monitoring method according to Note 11, in which
the learned model is capable of distinguishing and detecting each of plural types of individual motions as the second-drowning-state in the monitor image, and
the detection information that can be included in the swimming-state information can include information that makes it possible to identify each of the plural types of individual motions as the second-drowning-state.

### Note 13

The swimmer monitoring method according to Note 11 or 12, in which
the learned model is capable of distinguishing and detecting each of plural types of individual motions as a dangerous motion that poses a risk that possibly results in a drowning state in the monitor image,
the alert target swimmer indicated by the detection information that can be included in the swimming-state information further includes a dangerous-action swimmer estimated to perform the dangerous motion, and
the detection information that can be included in the swimming-state information can include information that makes it possible to identify each of the plural types of individual motions as the dangerous motion.

### Note 14

The swimmer monitoring method according to any one of Notes 11 to 13, in which
the swimming-state information can include the detection information on the alert target swimmer in such a manner as to enable the first-drowning-state, the second-drowning-state and a third-drowning-state to be distinguished from each other, the third-drowning-state being a state of drowning and floating with a face being below a surface of water, the alert target swimmer including the first-state swimmer and the second-state swimmer and further including a third-state swimmer estimated to be in the third-drowning-state.

### Note 15

The swimmer monitoring method according to any one of Notes 11 to 14, in which
the detection information that can be included in the swimming-state information further includes a probability value for each of the alert target swimmer, and
the generating step includes determining whether or not to generate the drowning alert information on a basis of the probability value included in the detection information of the swimming-state information.

### Note 16

The swimmer monitoring method according to any one of Notes 11 to 15, in which
the detection information that can be included in the swimming-state information further includes image area information on the alert target swimmer in the monitor image for each of the alert target swimmer, and
the generating step includes generating the drowning alert information including a monitor image in which an image area of one or a plurality of the alert target swimmers is designated, on a basis of the image area information included in the detection information of the swimming-state information.

### Note 17

The swimmer monitoring method according to any one of Notes 11 to 16, in which
the learned model is capable of distinguishing and detecting the alert target swimmer with a float and the alert target swimmer without a float in the monitor image, and
the detection information that can be included in the swimming-state information further includes information that makes it possible to distinguish the alert target swimmer with a float and the alert target swimmer without a float.

### Note 18

The swimmer monitoring method according to Note 17, in which
the learned model is capable of detecting motions, in the monitor image, that differ from each other between the second-drowning-state of the second-state swimmer with a float and the second-drowning-state of the second-state swimmer without a float.

### Note 19

The swimmer monitoring method according to any one of Notes 11 to 18, in which
the acquired monitor image is a wide-angle image captured by a wide-angle camera, and
the learned model is trained at least by using, as training data:
   the monitor image in which a swimmer in the first-drowning-state is shown in a middle area;
   the monitor image in which the swimmer in the first-drowning-state is shown in a first partial area;
   the monitor image in which the swimmer in the first-drowning-state is shown in a second partial area disposed at an opposite side of the middle area from the first partial area;
   the monitor image in which a swimmer in the second-drowning-state is shown in the middle area;
   the monitor image in which the swimmer in the second-drowning-state is shown in the first partial area; and
   the monitor image in which the swimmer in the second-drowning-state is shown in the second partial area.

### Note 20

The swimmer monitoring method according to Note 14, in which
the acquired monitor image is a wide-angle image captured by a wide-angle camera, and
the learned model is trained at least by using, as training data:
   the monitor image in which a swimmer in the first-drowning-state is shown in a middle area;
   the monitor image in which the swimmer in the first-drowning-state is shown in a first partial area;
   the monitor image in which the swimmer in the first-drowning-state is shown in a second partial area disposed at an opposite side of the middle area from the first partial area;
   the monitor image in which a swimmer in the second-drowning-state is shown in the middle area;
   the monitor image in which the swimmer in the second-drowning-state is shown in the first partial area;
   the monitor image in which the swimmer in the second-drowning-state is shown in the second partial area;
   the monitor image in which a swimmer in the third-drowning-state is shown in the middle area;
   the monitor image in which the swimmer in the third-drowning-state is shown in the first partial area; and
   the monitor image in which the swimmer in the third-drowning-state is shown in the second partial area.

1. A swimmer monitoring device comprising:
an image acquiring means configured to acquire a monitor image obtained by capturing an aquatic location from a position higher than a surface of water;
an information acquiring means configured to acquire swimming-state information outputted from a learned model by inputting the acquired monitor image into the learned model; and
a generating means configured to generate drowning alert information on a swimmer on a basis of the acquired swimming-state information, wherein
the swimming-state information can include detection information on an alert target swimmer in such a manner as to enable a first-drowning-state and a second-drowning-state to be distinguished from each other, the first-drowning-state being a state of drowning and sinking in water, a second-drowning-state involving a movement of a body and being differing from the first-drowning-state, the alert target swimmer including at least a first-state swimmer estimated to be in the first-drowning-state and a second-state swimmer estimated to be in the second-drowning-state.

2. The swimmer monitoring device according to claim 1, wherein
the learned model is capable of distinguishing and detecting each of plural types of individual motions as the second-drowning-state in the monitor image, and
the detection information that can be included in the swimming-state information can include information that makes it possible to identify each of the plural types of individual motions as the second-drowning-state.

3. The swimmer monitoring device according to claim 1, wherein
the learned model is capable of distinguishing and detecting each of plural types of individual motions as a dangerous motion that poses a risk that possibly results in a drowning state in the monitor image,
the alert target swimmer indicated by the detection information that can be included in the swimming-state information further includes a dangerous-action swimmer estimated to perform the dangerous motion, and
the detection information that can be included in the swimming-state information can include information that makes it possible to identify each of the plural types of individual motions as the dangerous motion.

4. The swimmer monitoring device according to claim 1, wherein
the swimming-state information can include the detection information on the alert target swimmer in such a manner as to enable the first-drowning-state, the second-drowning-state and a third-drowning-state to be distinguished from each other, the third-drowning-state being a state of drowning and floating with a face being below a surface of water, the alert target swimmer including the first-state swimmer and the second-state swimmer and further including a third-state swimmer estimated to be in the third-drowning-state.

5. The swimmer monitoring device according to claim 1, wherein
the detection information that can be included in the swimming-state information further includes a probability value for each of the alert target swimmer, and
the generating means determines whether or not to generate the drowning alert information on a basis of the probability value included in the detection information of the swimming-state information.

6. The swimmer monitoring device according to claim 1, wherein
the detection information that can be included in the swimming-state information further includes image area information on the alert target swimmer in the monitor image for each of the alert target swimmer, and
the generating means generates the drowning alert information including a monitor image in which an image area of one or a plurality of the alert target swimmers is designated, on a basis of the image area information included in the detection information of the swimming-state information.

7. The swimmer monitoring device according to claim 1, wherein
the learned model is capable of distinguishing and detecting the alert target swimmer with a float and the alert target swimmer without a float in the monitor image, and
the detection information that can be included in the swimming-state information further includes information that makes it possible to distinguish the alert target swimmer with a float and the alert target swimmer without a float.

8. The swimmer monitoring device according to claim 7, wherein
the learned model is capable of detecting motions, in the monitor image, that differ from each other between the second-drowning-state of the second-state swimmer with a float and the second-drowning-state of the second-state swimmer without a float.

9. The swimmer monitoring device according to claim 1, wherein
the monitor image acquired by the image acquiring means is a wide-angle image captured by a wide-angle camera, and
the learned model is trained at least by using, as training data:
the monitor image in which a swimmer in the first-drowning-state is shown in a middle area;
the monitor image in which the swimmer in the first-drowning-state is shown in a first partial area;
the monitor image in which the swimmer in the first-drowning-state is shown in a second partial area disposed at an opposite side of the middle area from the first partial area;
the monitor image in which a swimmer in the second-drowning-state is shown in the middle area;
the monitor image in which the swimmer in the second-drowning-state is shown in the first partial area; and
the monitor image in which the swimmer in the second-drowning-state is shown in the second partial area.

10. The swimmer monitoring device according to claim 4, wherein
the monitor image acquired by the image acquiring means is a wide-angle image captured by a wide-angle camera, and
the learned model is trained at least by using, as training data:
the monitor image in which a swimmer in the first-drowning-state is shown in a middle area;
the monitor image in which the swimmer in the first-drowning-state is shown in a first partial area;
the monitor image in which the swimmer in the first-drowning-state is shown in a second partial area disposed at an opposite side of the middle area from the first partial area;
the monitor image in which a swimmer in the second-drowning-state is shown in the middle area;
the monitor image in which the swimmer in the second-drowning-state is shown in the first partial area;
the monitor image in which the swimmer in the second-drowning-state is shown in the second partial area;
the monitor image in which a swimmer in the third-drowning-state is shown in the middle area;
the monitor image in which the swimmer in the third-drowning-state is shown in the first partial area; and
the monitor image in which the swimmer in the third-drowning-state is shown in the second partial area.

11. A swimmer monitoring method performed by one or more processors capable of using a learned model, wherein the one or more processors execute:
acquiring a monitor image obtained by capturing an aquatic location from a position higher than a surface of water;
acquiring swimming-state information outputted from the learned model by inputting the acquired monitor image into the learned model; and
generating drowning alert information on a swimmer on a basis of the acquired swimming-state information, wherein
the swimming-state information can include detection information on an alert target swimmer in such a manner as to enable a first-drowning-state and a second-drowning-state to be distinguished from each other, the first-drowning-state being a state of drowning and sinking in water, a second-drowning-state involving a movement of a body and being differing from the first-drowning-state, the alert target swimmer including at least a first-state swimmer estimated to be in the first-drowning-state and a second-state swimmer estimated to be in the second-drowning-state.

12. The swimmer monitoring method according to claim 11, wherein
the swimming-state information can include the detection information on the alert target swimmer distinguishable between the first-drowning-state, the second-drowning-state and a third-drowning-state, the third-drowning-state being a state of drowning and floating with a face being below a surface of water, the alert target swimmer including the first-state swimmer and the second-state swimmer and further including a third-state swimmer estimated to be in the third-drowning-state.

13. The swimmer monitoring method according to claim 11, wherein
the learned model is capable of distinguishing and detecting each of plural types of individual motions as a dangerous motion that poses a risk that possibly results in a drowning state in the monitor image,
the alert target swimmer indicated by the detection information that can be included in the swimming-state information further includes a dangerous-action swimmer estimated to perform the dangerous motion, and
the detection information that can be included in the swimming-state information can include information that makes it possible to identify each of the plural types of individual motions as the dangerous motion.

14. The swimmer monitoring method according to claim 11, wherein
the swimming-state information can include the detection information on the alert target swimmer in such a manner as to enable the first-drowning-state, the second-drowning-state and a third-drowning-state to be distinguished from each other, the third-drowning-state being a state of drowning and floating with a face being below a surface of water, the alert target swimmer including the first-state swimmer and the second-state swimmer and further including a third-state swimmer estimated to be in the third-drowning-state.

15. The swimmer monitoring method according to claim 11, wherein
the detection information that can be included in the swimming-state information further includes a probability value for each of the alert target swimmer, and
said generating the drowning alert information includes determining whether or not to generate the drowning alert information on a basis of the probability value included in the detection information of the swimming-state information.

16. The swimmer monitoring method according to claim 11, wherein
the detection information that can be included in the swimming-state information further includes image area information on the alert target swimmer in the monitor image for each of the alert target swimmer, and
said generating the drowning alert information includes generating the drowning alert information including a monitor image in which an image area of one or a plurality of the alert target swimmers is designated, on a basis of the image area information included in the detection information of the swimming-state information.

17. The swimmer monitoring method according to claim 11, wherein
the learned model is capable of distinguishing and detecting the alert target swimmer with a float and the alert target swimmer without a float in the monitor image, and
the detection information that can be included in the swimming-state information further includes information that makes it possible to distinguish the alert target swimmer with a float and the alert target swimmer without a float.

18. The swimmer monitoring method according to claim 17, wherein
the learned model is capable of detecting motions, in the monitor image, that differ from each other between the second-drowning-state of the second-state swimmer with a float and the second-drowning-state of the second-state swimmer without a float.

19. The swimmer monitoring method according to claim 11, wherein
the acquired monitor image is a wide-angle image captured by a wide-angle camera, and
the learned model is trained at least by using, as training data:
the monitor image in which a swimmer in the first-drowning-state is shown in a middle area;
the monitor image in which the swimmer in the first-drowning-state is shown in a first partial area;
the monitor image in which the swimmer in the first-drowning-state is shown in a second partial area disposed at an opposite side of the middle area from the first partial area;
the monitor image in which a swimmer in the second-drowning-state is shown in the middle area;
the monitor image in which the swimmer in the second-drowning-state is shown in the first partial area; and
the monitor image in which the swimmer in the second-drowning-state is shown in the second partial area.

20. The swimmer monitoring method according to claim 14, wherein
the acquired monitor image is a wide-angle image captured by a wide-angle camera, and
the learned model is trained at least by using, as training data:
the monitor image in which a swimmer in the first-drowning-state is shown in a middle area;
the monitor image in which the swimmer in the first-drowning-state is shown in a first partial area;
the monitor image in which the swimmer in the first-drowning-state is shown in a second partial area disposed at an opposite side of the middle area from the first partial area;
the monitor image in which a swimmer in the second-drowning-state is shown in the middle area;
the monitor image in which the swimmer in the second-drowning-state is shown in the first partial area;
the monitor image in which the swimmer in the second-drowning-state is shown in the second partial area;
the monitor image in which a swimmer in the third-drowning-state is shown in the middle area;
the monitor image in which the swimmer in the third-drowning-state is shown in the first partial area; and
the monitor image in which the swimmer in the third-drowning-state is shown in the second partial area.
